(19) United States
(12) Patent Application Publication
(10) Pub. No.: US 2013/0251853 A1
(43) Pub. Date: Sep. 26, 2013

(54) MODIFIED AGAVE FOOD AND METHOD OF MAKING SAME

(71) Applicant: Ciranda, Inc., Hudson, WI (US)

(72) Inventor: James Mitchell, Manteca, CA (US)

(21) Appl. No.: 13/850,053

(22) Filed: Mar. 25, 2013

Related U.S. Application Data
(60) Provisional application No. 61/614,968, filed on Mar. 23, 2012.

(51) Int. Cl. A23L 1/09

(52) U.S. Cl. CPC A23L 1/095
USPC 426/48

(57) ABSTRACT

Embodiments of the present disclosure are directed to a method for making agave syrup, the method including, mashing the agave piñas; extracting the inulin from the piñas; monitoring the hydrolysis with an osmometer; hydrolyzing the inulin to create specific saccharide functionality; pH adjusting the syrup to promote and stop hydrolysis; and heating the syrup to a temperature sufficient to deactivate native enzymes.

### CROSS REFERENCE TO RELATED APPLICATIONS

The present application claims priority to U.S. Provisional Application 61/614,968, which was filed Mar. 23, 2012 and is hereby incorporated herein in its entirety.

### FIELD OF THE INVENTION

The present disclosure relates to an agave food product and method for making same. More particularly, the disclosure relates to an agave syrup containing fiber and sugar in various compositions and methods of making the same. The product of the present disclosure may be beneficially used in many industries and applications including, but not limited to, the food industry.

### BACKGROUND OF THE INVENTION

The agave syrup currently available contains less than about 12% inulin, the remainder being simple sugars, mostly fructose (>80%). Fructose is currently viewed at best as a neutral sweetener, and at worst as a leading cause of obesity. Inulin, however, has well known health benefits, such as improved calcium uptake, increased immune response, and promoting a better blood lipid profile. Prior art in the agave industry has focused on either the inulin, or the high fructose agave syrup, but not the method for making an intermediate food product or syrup containing a mixture of both inulin and fructose in a repeatable method.

Current agave products go to one of two easily controlled endpoints: 1) inulin with very minor random hydrolysis; or 2) syrup with full hydrolysis. While it is technically possible to control the hydrolysis through the use of a High Performance Liquid Chromatography (“HPLC”) analysis, the time needed to perform the test would mean that the results would no longer be accurate. A current HPLC test can take over one hour between test start and testing results. Add in a variable rate of hydrolysis from residual native enzymes, and the current process is not commercially viable for production of mid-range agave syrups of consistent functionality. In addition, such testing is focused on fructose, glucose and sucrose fractions, which do not encompass the complete functionality of mid-conversion syrups.

Both inulin and high fructose agave syrup have limited functionality in foods. The syrup may be beneficial as a humectant, sweetener and browning agent, but lacks functionality in crystal control, bodying, filming, emulsion stabilization, binding, foam stabilization, etc. The inulin similarly lacks functionality in many areas, for example, but not limited to humectancy, sweetening, fermentability, freeze point suppression, osmotic pressure, etc. This lack of functionality limits the market for agave products to those that compete with sweeteners (sugar, invert cane, high fructose corn syrup, honey, etc.), or compete in the fiber market (resistant starches, gums, modified starches, etc.).

Since 1849, the hydrolysis of glucose syrups has been controlled using the Fehling test for oxidizing sugars, which gave a Dextrose Equivalent (DE) number. The DE number describes the conversion of starch to dextrose. The DE gives an indication of the average degree of polymerization (DP) for starch sugars. The rule of thumb is DE×DP=120. The test procedure generally includes titration and color analysis. This testing led to the ability to standardize glucose syrups into highly repeatable products. The ability to make the same partially hydrolyzed syrups from differing production facilities and differing crops allowed the food industry to use the syrups to create dependable products. Glucose syrups now are one of the most widely used ingredients in food manufacturing. Unfortunately, the Fehling test does not work with inulin or agave syrups.

There is a need for a commercially viable, repeatable, controllable food product or syrup that has the benefits of inulin.

### BRIEF SUMMARY OF THE INVENTION

Embodiments of the present disclosure are directed to a method for making agave syrup, the method including, mashing the agave piñas; extracting the inulin from the piñas; monitoring the hydrolysis with an osmometer; hydrolyzing the inulin to create specific saccharide functionality; pH adjusting the syrup to promote and stop hydrolysis; and heating the syrup to a temperature sufficient to deactivate native enzymes.

In another embodiment, the present disclosure is directed to a method for making an agave syrup. The method includes adding water to dried inulin; hydrolyzing the inulin to a predetermined level to create specific saccharide functionality to create a syrup, wherein the rate of hydrolysis of the inulin is measured using an osmometer as hydrolysis proceeds; adjusting the pH of the syrup to promote hydrolysis until the predetermined stopping point has been reached; and heating the syrup to a temperature sufficient to deactivate the native enzymes in the syrup, thereby preventing uncontrolled hydrolysis.

In still another embodiment, the present disclosure is directed to a method for making an agave syrup that includes mashing piña of one or more Blue Weber agave roots; mixing the mashed roots with warm water to dissolve the inulin into a syrup, wherein the rate of hydrolysis of the inulin is measured using an osmometer; hydrolyzing the inulin to a predetermined level to create specific saccharide functionality to create a syrup, wherein the rate of hydrolysis of the inulin is measured using an osmometer as hydrolysis proceeds; adjusting the pH of the syrup to promote hydrolysis until the predetermined stopping point has been reached; stopping hydrolysis by using a food grade caustic; and heating the syrup to a temperature sufficient to deactivate the native enzymes in the syrup to create a final syrup product.

In some cases the predetermined level of hydrolysis is selected to provide saccharide functionality corresponding to a starch syrup with a Dextrose Equivalent of 27-32. In other embodiments, the predetermined level of hydrolysis is selected to provide saccharide functionality corresponding to a starch syrup with a Dextrose Equivalent of 40-45; while in still other embodiments it may be 58-63.

The hydrolysis may be stopped or halting by the addition of a food grade caustic, in some embodiments. The food grade caustic may is sodium hydroxide, in some embodiments.

In other embodiments, hydrolysis maybe stopped or halted by using ion exchange resins.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 is a flow chart describing the manufacturing process for an agave syrup, in accordance with embodiments of the present disclosure.

FIG. 2 is a table providing the osmolality ranges for syrups with specific DE values.

### DETAILED DESCRIPTION

The present disclosure is generally directed to a health promoting agave syrup and method of making the same. More particularly, embodiments of the present disclosure are directed to an agave syrup that may be manufactured using a relatively fast test for determining the level of hydrolysis of the inulin, thereby allowing for a more precise level of control of the degree of hydrolysis of the finished product. For example, in some embodiments, a test that takes approximately two minutes to complete may yield a generally accurate, and in some embodiments a very accurate, determination of the average degree of polymerization. As such, an agave syrup can be created according to embodiments of the present disclosure, whereby the agave syrup has a predetermined DE value to correspond with the DE value of a glucose syrup. Accordingly, the agave syrup will have similar functionality as the glucose syrup having generally the same DE value. Thus, the agave syrup may be used as a substitute for the glucose syrup with little to no change in the taste, feel, or other properties of the resulting product, for example. Further, advantageously, the agave syrup substitute may have less calories, and may supply more fiber than the glucose alternative.

In some embodiments, a syrup may be made whereby a novel and advantageous method for controlling the rate of hydrolysis used. In one embodiment, the control method involves heating the inulin containing liquid to a temperature above about 190° F. to deactivate the natural enzymatic activity. This is desirable as the amount of enzymes in each batch varies, and so the rate of hydrolysis is variable, as it depends on the quantity of enzymes present.

According to another embodiment, the control method generally provides a quick, less than about 10 minutes and in many cases less than about 5 minutes, measurement of the degree of hydrolysis, using an osmometer to quickly measure the amount of moles in a solution, thereby providing a direct indication of the degree of hydrolysis. As opposed to traditional control scenarios, where the quantity of sugars and short chain molecules are quantified, the present method controls not the sugars, but the degree of hydrolysis, a much more precise measurement for syrups not fully hydrolyzed.

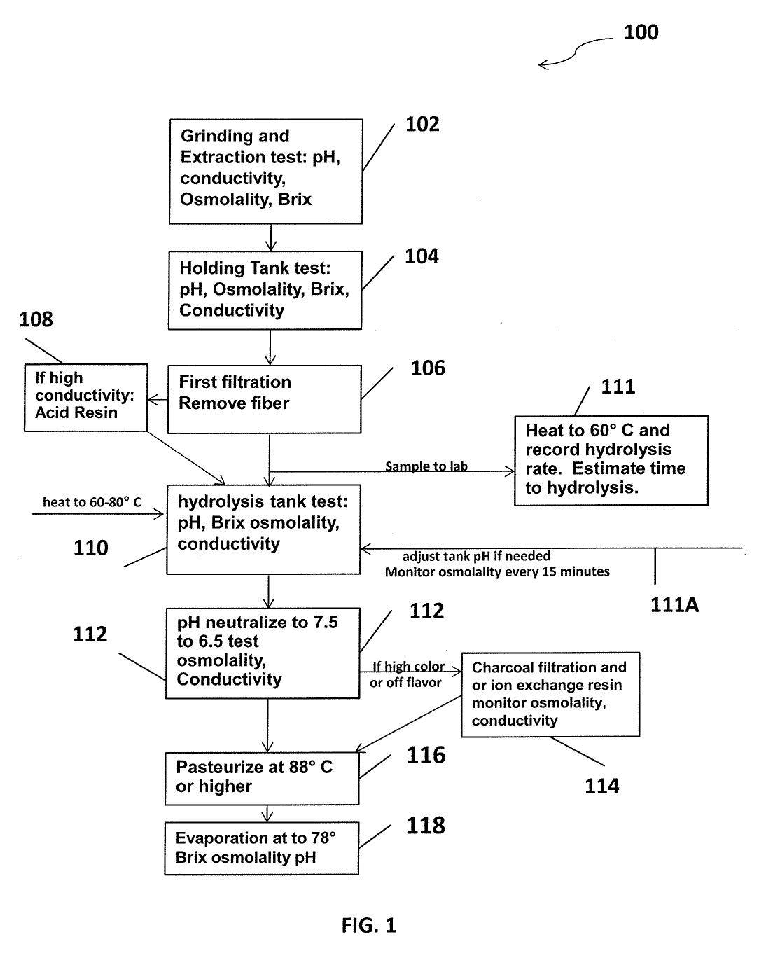

FIG. 1 shows a process 100 for hydrolyzing agave inulin to syrup, according to some embodiments of the present disclosure. The process for making agave syrup generally includes harvesting the agava root and grinding the agave piñas (core) 102. In some embodiments, specifically Blue Weber agave roots may be used, though in other embodiments any suitable type of agave root may be used. In other embodiments, a dried agave inulin may be rehydrated to supply a liquid inulin. The pH and osmolality may be monitored during this step 102, because hydrolysis may typically begin here because of the native enzymes and/or low pH. The mashed piñas may be mixed with warm water to dissolve the inulin 104 in the holding tank. The osmolality continues to be monitored in the holding tank at step 104. In some embodiments the liquid may be heated to deactivate native enzymes resident in the liquid to prevent uncontrolled hydrolysis. The syrup may then be clarified to remove the course insoluble fiber and extraneous materials 106. If the liquid has a high mineral content as shown by a conductivity reading for example, an acid resin exchange column may be used 108, which may also adjust the pH to a lower level. If the conductivity is acceptable, the fiber may be sent directly to the hydrolysis tank 110. The pH of the liquid may be lowered to below about pH 4.5 in some cases and heated to hydrolyze the inulin and create fructo oligosaccharides (“FOS”), shorter chain inulin, and sugars of differing amounts. A sample of the liquid may be sent to the lab in order to have the lab adjust the pH and/or to have the rate of hydrolysis at the targeted pH using the osmometer to check the rate of change 111, in some embodiments. Once the rate of hydrolysis is known, the inulin liquid in the hydrolysis tank may be pH adjusted to the target determined form the lab sample 111A. For example, the hydrolysis may be measured every 15 minutes to confirm the hydrolysis rate. Though it will be understood that the rate may be measured more or less frequently as desired. On reaching the desired osmolality, the liquid may be neutralized to about 6.0 pH to about 8.5 pH, in some embodiments.

As the target osmolality is approached, a stopping point is determined by the time it takes to neutralize the acidity level and also by the hydrolysis rate. The stopping point may be calculated to produce a material at/above about pH 6.0 in some cases, that is within the parameters of the desired syrup 112. In some embodiments, part of the pH adjustment can be done by additional ion exchange using caustic resin 114. The liquid once neutralized may be charcoal filtered to clarify and remove any off flavors 114. The liquid product may be pasteurized 116 and evaporated 118 to the desired solids content, in some embodiments. The composition of the resulting syrup in some embodiments may include fiber from about 10 to about 95%, and may include sugar from about 5 to about 90%. In some embodiments, the amount of sugar may be from about 40 to about 90%, for example.

With the use of the osmometer at the critical hydrolysis points, the rate of hydrolysis may be relatively quickly measured. Embodiments of the present disclosure include stopping hydrolysis at the proper point in production to achieve the desired end product. Hydrolysis may be stopped by one of two different actions, for example. The first action includes adjusting the pH of the liquid to above about 6.0, and in some embodiments to between about 7 to about 7.5 pH. This can be achieved by adding a food grade caustic or by the use of ion exchange resins, either of which will generally stop the acid hydrolysis process. In most cases, a single pass through a caustic ion exchange column may be sufficient to raise the pH above 6.0. Using sodium hydroxide, for example, at about 0.2% on a solids basis may be sufficient to stop the hydrolysis process. The second action that may generally stop hydrolysis includes heating the liquid to above about 190° F. (87.8° C.) to deactivate any naturally occurring enzymes.

Because performing these steps takes time, accurate and generally up-to-date knowledge of the hydrolysis rate may be important. Using the rate of hydrolysis and the knowledge of the time for performing the hydrolysis stopping actions allows for the ability to generally accurately time when to stop hydrolysis. Because hydrolysis continues during the process of adjusting the pH, and heating of the syrup, such actions may be undertaken prior to reaching the desired finished osmolality.

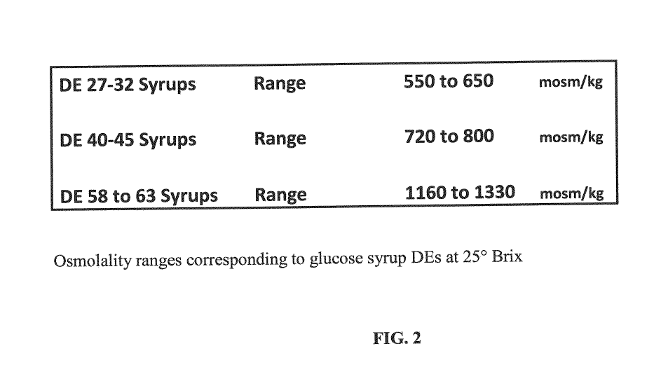

FIG. 2 is a chart showing the osmolality range for three standard glucose syrups. Rather than stopping at a certain fructose content or inulin content, embodiments of the present disclosure include stopping hydrolysis at an osmolality point that corresponds to a glucose syrup DE. The resulting agave syrup then performs functionally like the glucose syrup in most application.

In some embodiments, the syrups may comprise an amount of soluble fiber, ranging from about 10 to about 95% of the dry substance. In other embodiments the amount of soluble fiber may be more or less.

In some embodiments, the syrup includes FOS, inulin and sugars of various ratios, ranging from about 95% fiber (FOS and Inulin) to about 10% fiber, and about 90% sugars (fructose, glucose, sucrose) to about 5% sugar.

### Example 1

Agave piñas are ground and pressed, then put in a diffuser with hot water to extract the inulin yielding a solution at 18° Brix. “Brix” is used by the sucrose industry to measure the amount of sucrose solids in a sucrose solution using a Brix hydrometer, which is calibrated to read % w/w of sucrose solids at 20° C. The solution is monitored with an osmometer during this process to check for hydrolysis. The liquid is then filtered to remove fiber and the liquid heated to 60° C. When the osmolality is within the target range, the solution is pH adjusted to 7, and filtered with activated carbon. The liquid is then heated to 88° C. to and evaporated to concentrate the syrup. An agave syrup of saccharide osmolality 780 mosm/kg is used as a replacement for caramels. The formula for the caramels is: Sugar 24%; Syrup 32%; Cream 30%; Butter 14%. The final caramels have an identical texture and stand up tack free quality as caramels made with tapioca syrup.

An agave syrup of saccharide osmolality 780 mosm/kg is used to make a hard candy base, including: Syrup 48%; Sugar 52%. The result is a tack free glassine lozenge, with no crystallization with both agave syrup and glucose syrup.

The syrup of embodiments of the present disclosure may have relatively high amounts of fiber as compared to known glucose syrups. For example, embodiments of the present disclosure may include a fiber content of up to about 80% or higher, while a glucose syrup of comparable functionality may have less than 1% fiber.

### Example 2

Inulin is added to warm water at 120° F. When the solution is at 30° Brix, citric acid is used to lower the pH to 4.3. The solution is then boiled for 90 minutes. The hydrolysis is measured every 15 minutes with an advanced instruments osmometer model 3320. Monitoring the rate of hydrolysis, the heat is stopped and the liquid is neutralized as soon as it passes 750 Mosm/kg. The liquid is then concentrated in an evaporator.

Although the various embodiments of the present disclosure have been described with reference to preferred embodiments, persons skilled in the art will recognize that changes may be made in form and detail without departing from the spirit and scope of the present disclosure.

We claim:

1. A method for making an agave syrup, the method comprising:
mashing the piña of one or more agave root;
extracting the inulin from the piña, wherein the rate of hydrolysis of the inulin is measured using an osmometer;
hydrolyzing the inulin to a predetermined level to create specific saccharide functionality to create a syrup, wherein the rate of hydrolysis of the inulin is measured using an osmometer as hydrolysis proceeds;
adjusting the pH of the syrup to promote hydrolysis until the predetermined stopping point has been reached; and
heating the syrup to a temperature sufficient to deactivate the native enzymes in the syrup to create a final syrup product.

2. The method of claim 1, wherein the agave root used is a Blue Weber agave root.

3. The method of claim 1, wherein the predetermined level of hydrolysis is selected to provide saccharide functionality corresponding to a starch syrup with a Dextrose Equivalent of 27-32.

4. The method of claim 1, wherein the predetermined level of hydrolysis is selected to provide saccharide functionality corresponding to a starch syrup with a Dextrose Equivalent of 40-45.

5. The method of claim 1, wherein the predetermined level of hydrolysis is selected to provide saccharide functionality corresponding to a starch syrup with a Dextrose Equivalent of 58-63.

6. The method of claim 1, wherein the hydrolysis is stopped by adding a food grade caustic.

7. The method of claim 6, wherein the food grade caustic comprises sodium hydroxide.

8. The method of claim 1, wherein the hydrolysis is stopped by using ion exchange resins.

9. A method for making an agave syrup, the method comprising:
adding water to dried inulin;
hydrolyzing the inulin to a predetermined level to create specific saccharide functionality to create a syrup, wherein the rate of hydrolysis of the inulin is measured using an osmometer as hydrolysis proceeds;
adjusting the pH of the syrup to promote hydrolysis until the predetermined stopping point has been reached; and
heating the syrup to a temperature sufficient to deactivate the native enzymes in the syrup, thereby preventing uncontrolled hydrolysis.

10. The method of claim 9, wherein the agave root used is a Blue Weber agave root.

11. The method of claim 9, wherein the predetermined level of hydrolysis is selected to provide saccharide functionality corresponding to a starch syrup with a Dextrose Equivalent of 27-32.

12. The method of claim 11, wherein the predetermined level of hydrolysis is selected to provide saccharide functionality corresponding to a starch syrup with a Dextrose Equivalent of 40-45.

13. The method of claim 9, wherein the predetermined level of hydrolysis is selected to provide saccharide functionality corresponding to a starch syrup with a Dextrose Equivalent of 58-63.

14. The method of claim 9, wherein the hydrolysis is stopped by adding a food grade caustic.

15. The method of claim 14, wherein the food grade caustic comprises sodium hydroxide.

16. The method of claim 9, wherein the hydrolysis is stopped by using ion exchange resins.

17. A method for making an agave syrup, the method comprising:
mashing piña of one or more Blue Weber agave root;
mixing the mashed roots with warm water to dissolve the inulin into a syrup, wherein the rate of hydrolysis of the inulin is measured using an osmometer;
hydrolyzing the inulin to a predetermined level to create specific saccharide functionality to create a syrup, wherein the rate of hydrolysis of the inulin is measured using an osmometer as hydrolysis proceeds;
adjusting the pH of the syrup to promote hydrolysis until the predetermined stopping point has been reached;
stopping hydrolysis by using a food grade caustic; and
heating the syrup to a temperature sufficient to deactivate the native enzymes in the syrup to create a final syrup product.

18. The method of claim 17, wherein the food grade caustic sodium hydroxide.

19. The method of claim 17, wherein the predetermined level of hydrolysis is selected to provide saccharide functionality corresponding to a starch syrup with a Dextrose Equivalent of 27-32.

20. The method of claim 17, wherein the predetermined level of hydrolysis is selected to provide saccharide functionality corresponding to a starch syrup with a Dextrose Equivalent of 27-32.
